(19) United States
(12) Patent Application Publication
(10) Pub. No.: US 2002/0008891 A1
(43) Pub. Date: Jan. 24, 2002

(54) Substrate fixture for high-yield production of thin film based dense wavelength division multiplexers

(75) Inventors: Gerald T. Mearini, Shaker Heights, OH (US); Laszlo Takacs, Shaker Heights, OH (US)

Correspondence Address: Daniel A. Thomson, Esq., Fourteenth Floor, One Cascade Plaza, Akron, OH, 44308-1147, US

(73) Assignee: Atomic Telecom, Cleveland, OH

(21) Appl. No.: 09/902,408

(22) Filed: Jul. 10, 2001

Related U.S. Application Data
(60) Provisional application No. 60/217,115, filed on Jul. 10, 2000.
(60) Provisional application No. 60/217,060, filed on Jul. 10, 2000.

(51) Int. Cl. H04J 14/02; H04J 4/00; H04J 14/00

(52) U.S. Cl. 359/124; 359/123

(57) ABSTRACT

A substrate fixture has been designed, which significantly improves production yield of thin film based demultiplexer filters for use in Dense Wavelength Division Multiplexer (DWDM) systems. The fixture is comprised of a small area disk capable of rotational speeds greater than 1000 rpm with a dedicated concentric thin film quartz crystal thickness monitor and “clam shell” type shutter. The fixture is intended to be used in a vacuum deposition system, designed to perform optical coatings. The high-speed rotation and location of the fixture with respect to the deposition source guarantees coating thickness uniformity on substrates attached to the disk. The concentric quartz crystal thickness monitor (QCM) calibrated to the geometry or the deposition environment guarantees accurate thickness determination over the area of the disk to within 0.01 percent. The deposition system, designed to produce multilayer filters, for use as demultiplexers in DWDM systems, would utilize a dense array of fixtures of the type described herein for maximum production yield.

This application claims priority to U.S. Provisional Patent Application Serial No. 60/217,115, entitled SUBSTRATE FIXTURE FOR HIGH-YIELD PRODUCTION OF THIN FILM BASED DENSE WAVELENGTH DIVISION MULTIPLEXERS, filed on Jul. 10, 2000 and U.S. Provisional Patent Application Serial No. 60/217, 060, entitled HIGH THROUGHPUT HIGH-YIELD VACUUM DEPOSITION SYSTEM FOR THIN FILM BASED DENSE WAVELENGTH DIVISION MULTIPLEXERS, filed on Jul. 10, 2000.

### BACKGROUND OF THE INVENTION

A. Field Of The Invention

The present invention relates to a high speed rotational fixture assembly that has been designed to enable high yield production of thin film based demulitiplexers for DWDM (Dense Wavelength Division Multiplexer) systems. The fixture utilizes a dedicated thin film thickness monitor and shutter to allow individual thickness control of coatings on substrates positioned at various locations in a vacuum deposition system. The individual control compensates for variations in deposition rate, which are inherent in all deposition processes used to produce filters for high quality optics and telecommunication hardware components. Proper implementation of such fixtures should enable production yields of narrow band pass filters to improve significantly over yields currently achieved by conventional tooling.

DWDM systems enable information to be delivered inside fiber-optic cables at multiple wavelengths. The increase in the bandwidth is limited only by the number of wavelengths which can be superimposed on the fiber. Current state-of-the-art DWDMs can multiplex/demultiplex approximately 40 channels. Ultimately more than 1000 channels will be possible. During transmission, information is packaged within pulse-modulated carriers at specific wavelengths and superimposed (multiplexing) on the fiber. During reception, the carriers must be separated (demultiplexing). Optical component technology such as DWDM is critical in order to achieve the bandwidth necessary for future interactive services, such as “video on demand.”

The most widely used technology for DWDM multiplexer (mux) and demultiplexer (demux) devices is thin film-based. Multilayered, thin dielectric coatings are comprised of 150-200 layers with an individual optical layer thickness equal to multiples of ¼ of the wavelength to be transmitted (known as dielectric interference filters.) A collection of such filters, coupled together, each differing slightly in design to allow light transmission of different wavelengths, and “connected” to fiber-optic cable, enables the multiplexing (superposition) and demultiplexing (separation) of multiple wavelengths of laser light containing digital information.

B. Description Of The Related Art

Thin film coatings designed to permit light transmission/reflection over narrow (0.1-25 nm) and broad (>25 nm) pass bands are typically comprised of multiple layers of two or more optically matched materials of “high” and “low” indices of refraction. The individual layer thickness, and number of layers, will ultimately define the optical performance of the filter. Typical “high performance” narrow band filters may have more than 100 individual layers.

Thickness uniformity is critical in any optical filter application. Optical coating systems are typically designed to produce coatings with thickness uniformity of approximately 0.1 percent variation over the substrate area. This level of thickness control is insufficient for multilayered coatings designed for DWDM. Layer thickness determines wavelength and amplitude (loss) of transmitted light therefore, accurate thickness determination and reproducibility are crucial. Thickness non-uniformity of 0.1 percent will lead to filters that do not meet required specifications.

In practice, tens of substrates (approximately 6 inch square or round) are coated with multilayered filters, designed for DWDM in “traditional” IBSD (ion beam sputter deposition) or IAD (ion-assisted deposition) systems. A typical IAD production coating system is approximated by a 60-inch cube, with a fixture assembly located at the top of the vacuum chamber as shown schematically in FIG. 1. The planetary fixture assembly is designed for thickness uniformity described above and can accommodate approximately 24 6-inch square substrates. As many as 5 QCMs (quartz crystal monitor), and an optical monitor, are positioned about the chamber to monitor deposition rate and optical layer thickness. The quartz monitors are calibrated prior to production. Deposition rate incident on the substrate assembly is determined by sampling each monitor and averaging.

The substrates are diced into thousands of ˜1 mm squares (called dies or chips). Every coated die is tested for performance to determine which ones (if any) meet requirements. Presently, major manufactures, such as OCLI®, are reporting production yields of less than 5 percent. The demand for such filters is approaching 1,000,000 per month. This demand will not be met with current system configurations without a significant increase in capital equipment to increase capacity. Customers for the filters have relaxed requirements and settled for inadequate performance to continue with installation of DWDM systems.

Quartz crystal monitors are extremely sensitive to minute changes in thickness. The device is based on changes in frequency in the quartz oscillator resulting from increased mass present on the surface. Thickness can be determined from a relationship approximated by the equation:

T(nm)˜CΔν(Hz)/ρ(g/cm³)

Where T is the film thickness in nanometers, Δν is the change in oscillation frequency in Hz, ρ is the density of the deposited material in g/cm³ and C is a constant, effected by geometric properties of the deposition environment, and thermal and mechanical properties of the deposited material. With proper calibration, the QCM can accurately resolve differences in thickness less than 0.01 nm.

Deposition control processors are programmed with material data to allow the QCM to accurately determine thickness for identified materials. The material data included in the processor memory, or found in material handbooks, is often derived from ideal materials and do not necessarily reflect the properties of the thin film coating. In addition, the change in oscillation frequency is dependent upon the amount of material already present on the quartz crystal and the behavior of that material in the deposition environment. For these reasons, QCMs are not regarded as the preferred method of thickness and rate determination during optical filter production.

Currently, thin film filters for DWDM muxes and demuxes are produced with accepted yields of less than 5 percent, due to the complexity and uniformity requirements of the coatings designs. Coating equipment used for complex optical coatings is not optimally tooled to provide necessary uniformity for this application. Optical thickness monitors employed in most optical coating systems are not capable of resolving variations in thickness on the sub-angstrom level. Quartz crystal thickness monitors are more sensitive to changes in thickness, but are typically used inefficiently or improperly. This results in decreased accuracy of thickness determination vs. deposition time. The fixture design described in this document will increase accepted yields of thin film demultiplexers from 1 percent to 25-75 percent.

### SUMMARY OF THE INVENTION

In accordance with one aspect of the present, a high yield fixture for the production of demux filters for DWDM systems includes a disk, the disk adapted to be rotatable at greater than 2400 rpm during operation, a dedicated multi-crystal quartz crystal thickness monitor, an optical thickness monitor, a clam shell shutter, a magnetic induction rotation mechanism, and multiple substrates, the substrates located concentrically about the quartz crystal monitor.

In accordance with another aspect of the present invention, a high yield fixture for production of optical filters includes a thickness monitor, a rotating member, shuttering means for shuttering the fixture, at least one substrate, and rotating means for rotating the fixture, wherein the rotating member is a disk adapted to be rotated at greater than 500 rpm, wherein the thickness monitor is a dedicated quartz crystal monitor, wherein the shuttering means is a clam shell shutter.

In accordance with another aspect of the present invention, the fixture also includes multiple substrates, the substrates located concentrically about the monitor, wherein the substrate is divided into a grid of dies, wherein the rotating means is a magnetic induction rotation mechanism, wherein the rotating member is a disk adapted to be rotated at greater than

2400 rpm

In accordance with still another aspect of the present invention, a high speed substrate assembly for use in a line-of-sight deposition process includes multiple independent fixtures having at least one substrate, at least one thickness monitor, shuttering means for shuttering the fixture, and rotating means for rotating the fixture.

In accordance with yet another aspect of the present invention, the monitor includes a dedicated quartz crystal monitor and an optical thickness monitor.

In accordance with still another aspect of the present invention, the fixtures includes a rotatable disk, the at least one substrate and the monitors being located on the disk, wherein the at least one substrate is multiple substrates, the substrates being concentrically located about the quartz crystal monitor, wherein the shuttering means is a clam shell shutter, wherein the rotating means is a magnetic induction rotation mechanism.

In accordance with another aspect of the present invention, a method for creating substantially uniformly thick optical filters includes the steps of providing at least one evaporator, providing multiple independent fixtures, each of the fixtures having at least one substrate, at least one thickness monitor, shuttering means for shuttering the fixture, and rotating means for rotating the fixture, independently rotating the fixtures at greater than 500 rpm, independently monitoring layer thickness for each of the fixtures using the at least one thickness monitor, and independently shuttering the fixtures to ensure uniform deposition.

In accordance with yet another aspect of the present invention, the method includes the step of utilizing pulsed deposition to finish a layer.

In accordance with still another aspect of the present invention, the method includes the steps of independently rotating the fixtures at greater than 2400 rpm, providing multiple independent fixtures, each of the fixtures having multiple substrates, a quartz crystal monitor, an optical thickness monitor, shuttering means for shuttering the fixture, and rotating means for rotating the fixture, the substrates being concentrically located about the quartz crystal monitor, and independently monitoring layer thickness per revolution for each of the fixtures using the optical thickness monitor.

Still other benefits and advantages of the invention will become apparent to those skilled in the art upon a reading and understanding of the following detailed specification.

### BRIEF DESCRIPTION OF THE DRAWINGS

The invention is illustrated in the following drawings:

FIG. 1A is a perspective view of a prior art IAD vacuum deposition system;

FIG. 1B is a bottom view of a prior art planetary substrate assembly;

FIG. 2A is a top view of the inventive substrate fixture, showing the QCM, the substrates, and the rotational mechanism;

FIG. 2B is a side view of the inventive fixture;

FIG. 3A is a side view of the fixture with the clam shutter in the open position;

FIG. 3B is a side view of the fixture with the clam shutter in the closed position;

FIG. 3C is a top view of the fixture with the clam shutter in the open position;

FIG. 3D is a top view of the fixture with the clam shutter in the closed position;

FIG. 4 is a top view of a dense high yield fixture array, showing the inventive fixtures in both the open and closed positions; and, FIG. 5 is a perspective view of the inventive deposition system.

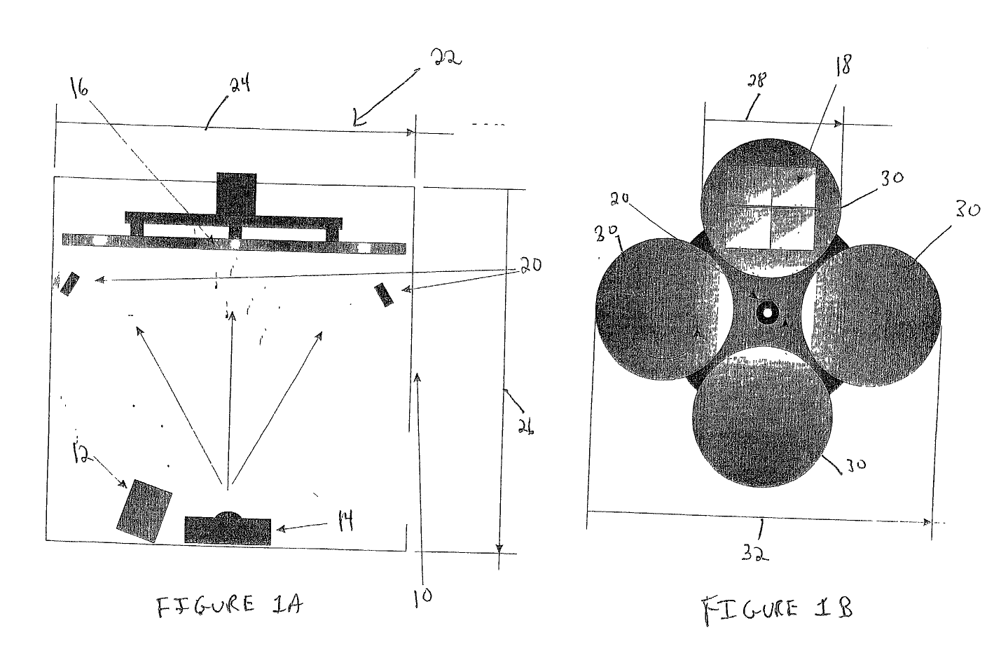

### DESCRIPTION OF THE INVENTION

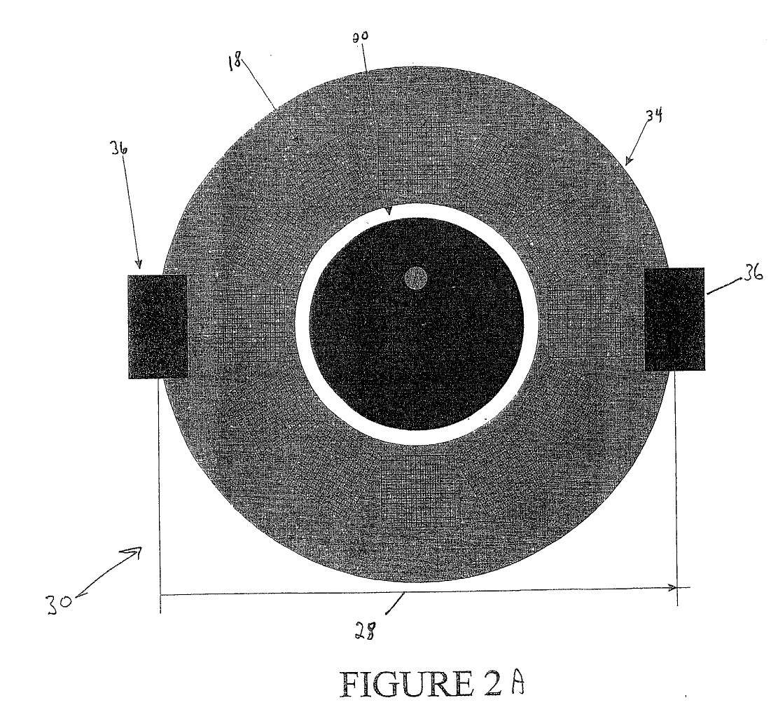

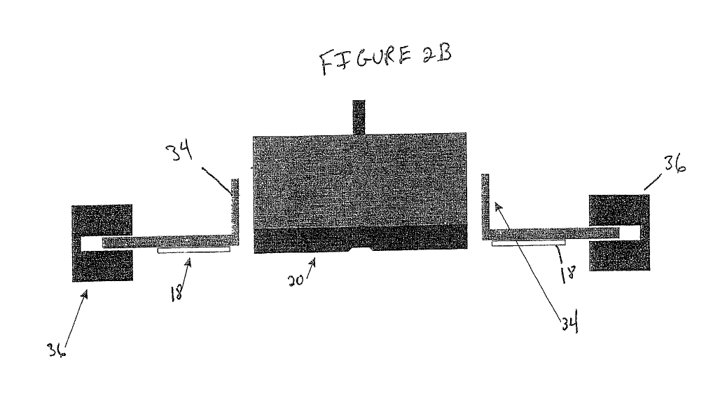

Referring now to the drawings, which are for purposes of illustrating at least one embodiment of the invention only, and not for purposes of limiting the invention, FIGS. 2A and 2B are a representation of a high yield fixture 30, call the Vomado™, which has been designed to produce demultiplexer filters for DWDM systems with greater than 25 percent accepted yield. The design is comprised of a disk 34 (which in this embodiment is approximately 8.5 inches in diameter) with a concentric multi-crystal QCM 20 and a dedicated shutter arrangement. In this embodiment, the disk 34 rotates at greater than 1000 rpm (the disk 34 may rotate as slowly as 500 rpm) during operation to ensure uniform deposition of material at typical coating deposition rates of 0.2-0.5 nm/s. Under these conditions, the disk 34 would perform equal to or greater than 20 revolutions for each atomic layer (monolayer) of deposited material. This ensures that angular variation of thickness is less than or equal to 1/20^{th} of a monolayer or approximately 0.02 nm.

With continuing reference to FIGS. 2A and 2B, the fixture 30 includes multiple substrates 18, rotation mechanism 36, a QCM 20, and a fixture diameter 28. The substrates 18, which are divided into multiple dies (shown but not referenced), are located concentrically about the QCM 20. In this embodiment, the rotating mechanisms 36 are magnetic induction mechanisms, and are located on either end of the fixture 30, as shown in FIG. 2A. This rotation mechanism 36 is not limited to this configuration. Rotation can be accomplished in any way which does not interfere with the line of sight from the deposition source to the substrate 18, and is chosen using sound engineering judgment.

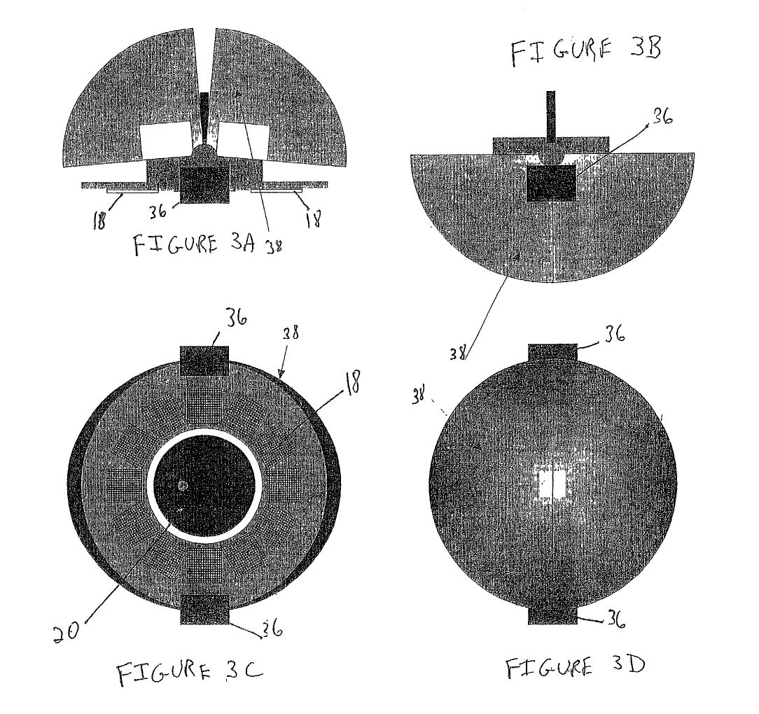

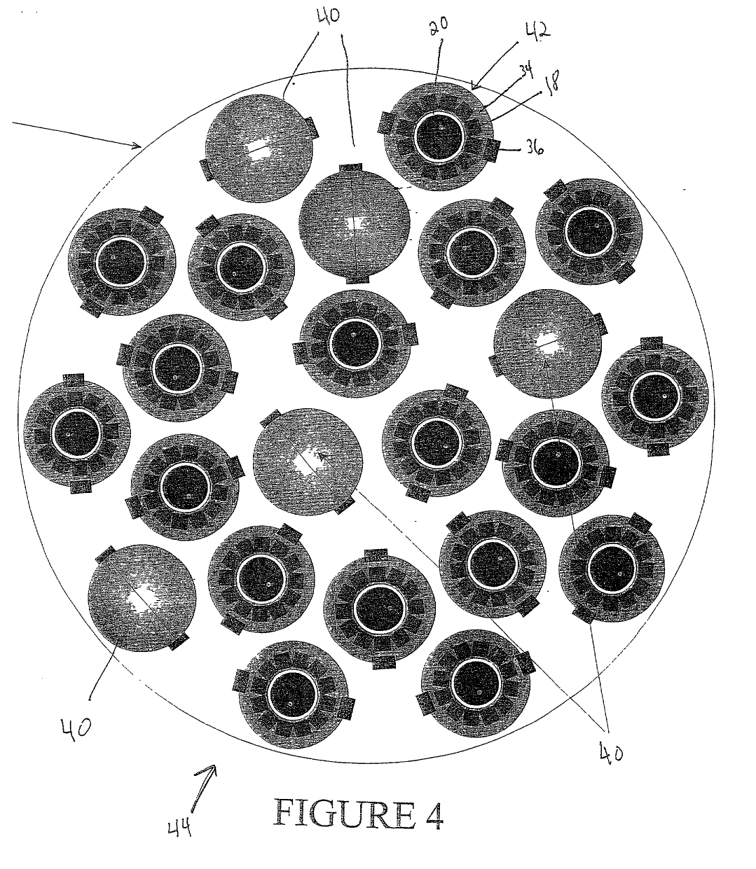

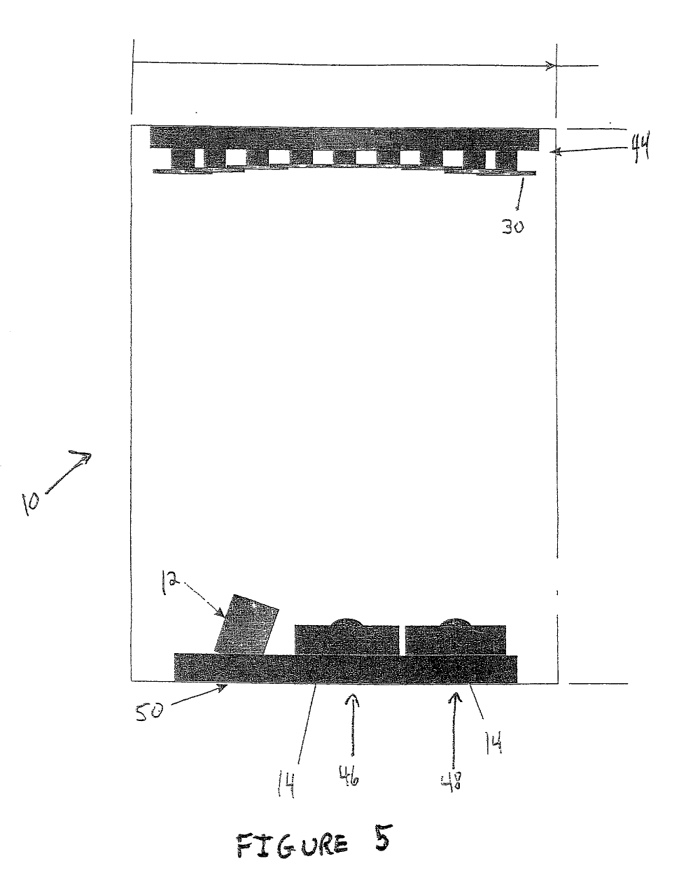

FIGS. 3A-3D show the fixture 30 with a “clam shell” type shutter 38. Any shutter arrangement, commonly used for vacuum coating applications, and chosen using sound engineering judgment, would be acceptable. It is desirable to minimize the area occupied by the entire fixture assembly 44, since maximum throughput is achieved with a dense array of fixtures 30 as shown in FIG. 4. FIGS. 3A and 3C show the fixture 30 in the open position. The clam shell shutter 38 occupies less space than other shutter arrangements, and covers all sides, as well as the face, of the fixture 30.

However, it is to be understood that any means for closing the fixture 30 can be used as long as chosen using sound engineering judgment. In this invention “shuttering” is intended to encompass any means of restricting access, or the line of sight, to the substrate 18. FIGS. 3B and 3D show the fixture 30 with the clam shell shutter 38 in the closed position. When in the closed position, the shutter 38 prevents further deposition, as access to substrate 18 is blocked. The ability to shutter the fixture 30 allows the uniform deposition of layers.

Since the QCM 20 can resolve sub-angstrom thickness changes, materials deposited onto the substrates 18, held less than 2 inches away, are monitored with high precision. Geometrical calibration of the QCM 20, to compensate of the position for the substrates 18, is straightforward. Thermal fluctuations resulting from heat capacity of the deposited materials and second order effects from mechanical stress must be determined. This is accomplished with standard analysis techniques for material characterization. From this data, it is straightforward to develop an algorithm to maintain accurate thickness information from layer to layer.

Instability in the QCM 20 occurs when it is initially exposed to the electron gun 14 due to thermal flux generated by the heated source material. A quartz window (not shown) can be embedded into the clam shutter 38, which would allow the quartz crystal to come to thermal equilibrium with the flux before deposited material must be monitored. Once thermal equilibrium was achieved, clam shutters 38 would open. Windows of this type would become less effective as the deposition progressed due to accumulation of evaporant, but would serve to improve the overall performance of the filters.

Thin filters are intended to be produced in the following way. Deposition is carried out with, but is not limited to, one of several conventional processes described above. Fixtures 30 are positioned approximately as shown in FIG. 4. During system calibration, the vertical position of each fixture 30 is individually adjusted to compensate for variations in depositions rate vs. chamber location.

As shown in FIGS. 4 and 5, the fixtures 30 are independent of one another, and can be in both an open 42 and closed 40 position. The fixtures 30 are rotatable independently of one another, and are also shuttered independently of one another. The independent nature of each of the fixtures 30 allows uniform deposition of the material onto the substrates 18.

As the thickness of an individual layer approaches the target value, as measured by the individual fixture QCM 20, the clam shutter 38 will close prior to achieving the target thickness. Individual fixtures 30 will be shuttered at different times, since like thicknesses will not be achieved simultaneously due to geometrical factors and nonuniform variations in deposition rate at different locations in the chamber 10. Each fixture 30 will be independently reopened to a low rate pulsed deposition process to achieve the target thickness. The low rate pulsed process may take as much time as the initial “bulk” coating.

The fixture 30 can be adapted to more advanced deposition processes proposed for DWDM systems, such as epitaxial growth and pulsed molecular beam deposition. With the implementation of these processes the QCM 20 is replaced with Reflection High Energy Electron Diffraction (RHEED) or interferometric thickness monitoring techniques, depending on the morphology of the deposited film. The basic concept of high-speed rotation remains unchanged and the result is a significant improvement in acceptable yield.

The invention has been described with reference to at least one embodiment. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

I/we claim:

1. A high yield fixture for the production of demultiplexer filters for dense wavelength division multiplexers, the fixture comprising:
a disk, the disk adapted to be rotatable at greater than 2400 rpm during operation;
a dedicated multi-crystal quartz crystal thickness monitor;
an optical thickness monitor;
a clam shell shutter;
a magnetic induction rotation mechanism; and,
multiple substrates, the substrates located concentrically about the quartz crystal monitor.

2. A high yield fixture for production of optical filters, the fixture comprising:
a thickness monitor;
a rotating member;
shuttering means for shuttering the fixture;
at least one substrate; and,
rotating means for rotating the fixture.

3. The fixture of claim 2, wherein the rotating member is a disk adapted to be rotated at greater than 500 rpm.

4. The fixture of claim 3, wherein the thickness monitor is a dedicated quartz crystal monitor.

5. The fixture of claim 4, wherein the shuttering means is a clam shell shutter.

6. The fixture of claim 5, wherein the fixture further comprises:
multiple substrates, the substrates located concentrically about the monitor.

7. The fixture of claim 6, wherein the substrate is divided into a grid of dies.

8. The fixture of claim 7, wherein the rotating means is a magnetic induction rotation mechanism.

9. The fixture of claim 8, wherein the rotating member is a disk adapted to be rotated at greater than 2400 rpm

10. A high speed substrate assembly for use in a line-of-sight deposition process, the assembly comprising:
multiple independent fixtures, the fixtures comprising:
at least one substrate;
at least one thickness monitor;
shuttering means for shuttering the fixture; and, rotating means for rotating the fixture.

11. The assembly of claim 10, wherein the at least one thickness monitor further comprises:
a dedicated quartz crystal monitor; and,
an optical thickness monitor.

12. The assembly of claim 11, wherein the fixtures further comprise:
a rotatable disk, the at least one substrate and the monitors being located on the disk.

13. The assembly of claim 12, wherein the at least one substrate is multiple substrates, the substrates being concentrically located about the quartz crystal monitor.

14. The assembly of claim 13, wherein the shuttering means is a clam shell shutter.

15. The assembly of claim 14, wherein the rotating means is a magnetic induction rotation mechanism.

16. A method for creating substantially uniformly thick optical filters, the method comprising the steps of:
providing at least one evaporator;
providing multiple independent fixtures, each of the fixtures having at least one substrate, at least one thickness monitor, shuttering means for shuttering the fixture, and rotating means for rotating the fixture;
independently rotating the fixtures at greater than 500 rpm;
independently monitoring layer thickness for each of the fixtures using the at least one thickness monitor; and,
independently shuttering the fixtures to ensure uniform deposition.

17. The method of claim 16, wherein the method further comprises the step of:
utilizing pulsed deposition to finish a layer.

18. The method of claim 17, wherein independently rotating the fixtures at greater than 500 rpm comprises the step of:
independently rotating the fixtures at greater than 2400 rpm.

19. The method of claim 18, wherein providing multiple independent fixtures, each of the fixtures having at least one substrate, at least one thickness monitor, shuttering means for shuttering the fixture, and rotating means for rotating the fixture
comprises the step of:
providing multiple independent fixtures, each of the fixtures having multiple substrates, a quartz crystal monitor, an optical thickness monitor, shuttering means for shuttering the fixture, and rotating means for rotating the fixture, the substrates being concentrically located about the quartz crystal monitor.

20. The method of claim 19, wherein independently monitoring layer thickness for each of the fixtures using the at least one thickness monitor comprises the step of:
independently monitoring layer thickness per revolution for each of the fixtures using the optical thickness monitor.
